(19) United States
(12) Patent Application Publication
(10) Pub. No.: US 2004/0007123 A1
(43) Pub. Date: Jan. 15, 2004

(54) Hermetically sealed actuator

(76) Inventors: Robert S. Ritchie, New Hall, CA (US); John A. Sudick, Castaic, CA (US)

Correspondence Address: MCANDREWS HELD & MALLOY, LTD, 500 WEST MADISON STREET, SUITE 3400, CHICAGO, IL, 60661

(21) Appl. No.: 10/192,243

(22) Filed: Jul. 10, 2002

(51) Int. Cl. B64D 1/04; F41F 5/00

(52) U.S. Cl. 89/1.14

(57) ABSTRACT

An actuator connected to receive high pressure gas from a pyrotechnic initiator incorporates a primary piston and a secondary piston mounted for limited movement along cylindrical bores in a housing; the pistons are held in a fixed inactive position and are restrained from movement within the housing by a tension screw connected to the primary piston and the housing. The tension screw incorporates a calibrated reduced diameter section that ruptures at a predetermined applied force to permit the pistons to move within the housing. Gaseous products resulting from initiation are trapped and maintained within the housing by an expandable bellows secured internally of the housing at one end of the bellows and secured at the opposite end of the bellows to the interior of the housing. A calibration/test port extends through the housing into the bore externally of the bellows to permit calibration and testing of the actuator without initiating the pyrotechnic device.

### FIELD OF THE INVENTION

The present invention pertains to devices responsive to the triggering of an initiator, such as a pyrotechnic device, to create a limited physical motion to perform a task such as rupturing a reservoir closure, or cutting cables, cords or bolts or similar function. More particularly, the present invention relates to actuator devices wherein the actuating gases or fluids resulting from actuation must be isolated from and not permitted to escape into the vicinity of the work being performed by the actuator and must be completely contained to prevent contamination of any working fluid that is being released from such reservoir or that might contaminate adjacent sensors, optics, or other sensitive surfaces.

### BACKGROUND OF THE INVENTION

Pyrotechnically activated valves are used in a number of aerospace applications. Systems that may be utilized in outer space often incorporate pyrotechnically initiated valves to control the flow of fluids, pressurized gases, or to activate other systems. The pyrotechnic initiation is accompanied by pyrotechnic combustion products that are usually considered contaminants if permitted to escape to other portions of the valve or the system in which the valve is mounted. Such down stream contamination can have very serious effects on the operation and performance of other systems including catastrophic failure of flight systems Such actuators are frequently used to push a piston, puncture a closure, or slide a shuttle in a sequence of operations; the initiation of the actuator may be chosen to respond to an electrical or laser signal, and to function with a number of different pyrotechnic initiators. Further, it is frequently important for the actuator to withstand substantial acceleration or rough handling without the operative portions of the actuator becoming dislodged or moving prior to the desired initiation signal.

### OBJECTS OF THE INVENTION

It is therefore an object of the present invention to provide an actuator that incorporate a hermetic seal to prevent the products of pyrotechnic initiation from contaminating the vicinity of the actuator external work area.

It is another object of the present invention to provide an actuator that may be activated utilizing pyrotechnic initiation wherein the products of the pyrotechnic activation are maintained within the actuator and prevented from exiting the actuator to contaminate other systems.

It is still another object of the present invention to provide a sealed actuator having internal parts responsive to the application of an initiation pressure wherein the parts are maintained in a pre-initiation position until a pressure above a predetermined minimum pressure is applied to the actuator.

It is still another object of the present invention to provide a sealed actuator responsive to the triggering of a pyrotechnic device wherein the actuator may be conveniently tested and calibrated without the utilization of pyrotechnic initiation and without the movement of any internal parts within the actuator.

It is still another object of the present invention to provide a sealed actuator responsive to pyrotechnic initiation for performing a task through the limited movement of an internal piston wherein the movement of the piston is prevented until the initiation pressure exceeds a predetermined value.

These and other objects of the present invention will become apparent to those skilled in the art as the description thereof proceeds.

### SUMMARY OF THE INVENTION

Briefly, in accordance with embodiment chosen for illustration, the present invention provides an actuator that may be activated using conventional techniques such as pyrotechnic initiation to move an internal piston to an actuated position wherein a designated function, such as the puncturing of a pressurized fluid container is accomplished. To insure that the products of combustion caused by the initiation of the pyrotechnic initiator do not contaminate the working fluid being released by the actuation and movement of the internal piston of the actuator, the internal piston and the surrounding bore within which the piston moves are provided with a bellows in hermetic sealing engagement with both the piston and the bore. To further insure that the combustion products do not contaminate the working fluid or adjacent surfaces, the piston and its bore within the housing are provided with a taper seal that locks the piston in its extended actuated position and seals the bore to prevent the escape of any contaminating substances or materials that may exist in the bore.

### BRIEF DESCRIPTION OF THE DRAWINGS

The present invention may more readily understood by reference to the accompanying drawings in which:

FIG. 1 is a top view of an actuator constructed in accordance with the teachings of the present invention.

FIG. 2 is a cross sectional view of FIG. 1 taken along line 2-2.

FIG. 3 is an exploded view of the actuator of FIGS. 1 and 2.

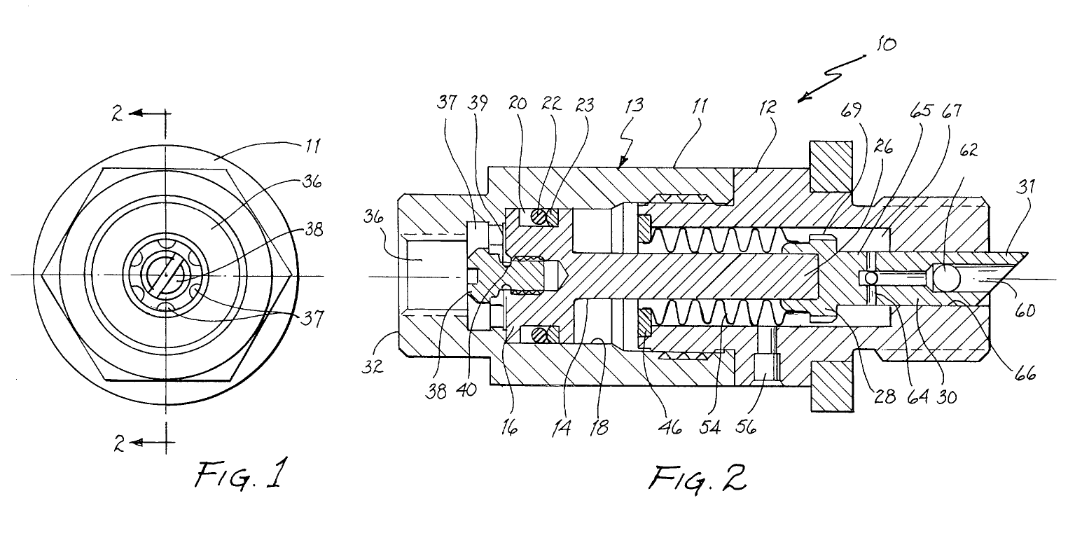

### DETAILED DESCRIPTION OF THE ILLUSTRATED EMBODIMENT

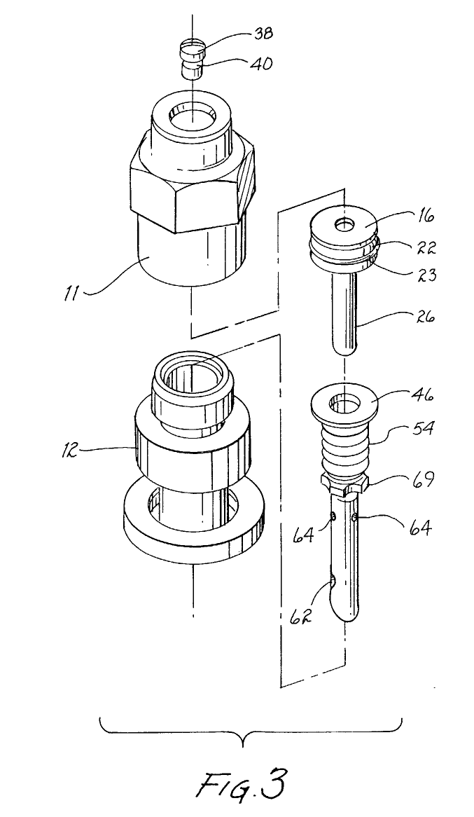

Referring to the drawings, the actuator 10 of the present invention incorporates a housing 13 formed of a base 12 and upper housing 11, respectively, that are threadedly coupled and subsequently welded to form a unitary structure. The provision of separate sections facilitates the manufacture of the actuator; however, it is important to seal the two sections together to maintain the hermetic seal provided by the actuator. The actuator 10 is provided with a primary piston 14 having a primary piston head 16 slidably mounted within a cylindrical bore 18 formed in the housing 13. The primary piston head 16 incorporates an annular groove 20 to receive sealing rings 22 and 23. The piston head 16 is formed integrally with a primary piston rod or extension 26 that nests within a secondary piston head 28 of the secondary piston 30. In the embodiment chosen for illustration, the actuator is chosen as a means to puncture a closure disc to permit the escape, through an end of the secondary piston, of fluid contained within a container. Therefore, the secondary piston 30 is shaped to form a cutter 31 as shown in FIG. 2.

One end 32 of the actuator housing 13 is provided with an initiator pressure chamber 36 for receiving a source of high pressure, such as an pressure cartridge that can be actuated electrically, by laser, or other initiation technique. A plurality of gas ports 37 provide communication between the initiator well 36 and the face 39 of the piston head 16. A tension screw 38 extends through the base of the pressure chamber 36 and threadedly engages the primary piston head 16. The tension screw 38 is provided with a calibrated reduced diameter section 40 to rupture at a predetermined applied force to permit the primary piston 14 to respond to the applied pressure and move along a cylindrical bore 18 formed in the housing 13. The tension screw 38 firmly maintains the primary piston in place and prevents accidental extension of the secondary piston as a result of handling or the imposition of acceleration to the actuator during its mounting and subsequent use. The reduced diameter section 40 of the tension screw 38 may accurately be calibrated to permit the screw to separate at a predetermined force exerted by expanding gases or fluids pressing upon the primary piston head 16 as the result of triggering an initiator. It may be noted that the pressure chamber 36 can be connected to receive any initiator to provide actuation by a cold gas supply, a hot wire pyrotechnic initiator, a laser-fired initiator, or an explosive transfer line tip. In any event, the calibrated reduced diameter section 40 of the tension screw 38 permits the actuator to be designed to respond only to pressures equal to or in excess of the force necessary to separate the tension screw and permit the primary piston head to extend into the cylindrical bore provided in the housing.

The primary piston rod or extension 26 passes through a metal washer 46, that is welded in place within the housing 12, and nests within the secondary piston head 28 as described above. A metal bellows 54 is positioned over the primary piston rod 26 and is welded at its opposite ends to the washer 46 and the secondary piston head 28 respectively. These welded attachments are fluid or gas tight attachments to form hermetic seals. The bellows 54 may be constructed of 300 series stainless steel or from other similar materials, such as Inconel 718. The bellows 54 in its contracted state as shown in FIG. 2 will mechanically connect the secondary piston head to the washer 46 and thus to the housing 13. In this position, the entire movable portion of the actuator comprising the primary piston 14 and secondary piston 30 will be held in a stationary position as shown in FIG. 2 until the rupture of the tension screw 38 at the calibrated reduced diameter section 40 thereof permits the movement of the primary piston to the right (as shown in FIG. 2), thus causing the secondary piston to move to the right and perform its intended function.

A calibration port 56 extends through the housing section 12 and communicates with the exterior of the bellows 54 within the cylindrical bore 67; the calibration port may be used to calibrate and test fluid flow in a manner to be described more fully hereinafter and will be plugged after such calibration and before the actuator is to be placed in service. The secondary piston 30 is shaped at one end thereof to form a cutter 31 as described previously and incorporates an axial fluid channel or flow cavity 60 extending from the operative cutter end 31 thereof, past a fluid passageway 62 and inwardly of the piston to a plurality of calibration channels 64. The secondary piston 30 is also provided with a taper 65; that is, the diameter of the secondary piston decreases from the vicinity of the secondary piston head 28 to the cutter end of the piston. This taper provides a seal against the similarly tapered channel 66 formed in the housing through which the secondary piston extends.

In operation, an appropriate initiator (not shown) is installed or mounted in the initiator well 36 may be actuated in any convenient manner to provide high pressure gas to impinge on the primary piston head 16. As this pressure builds, the calibrated threshold pressure is reached wherein the reduced diameter section 40 of the tension screw ruptures, permitting the gas pressure to force the primary piston head into the cylindrical bore 18 provided in the housing. As the piston head 16 strokes in the bore 18, the primary piston rod 26 correspondingly forces the secondary piston 30 outwardly of the housing. As the extension of the secondary piston occurs, the bellows 54 appropriately deforms to permit the extension of the bellows without breaking the seal formed by the welded connections of the ends of the bellow to the washer 46 and the secondary piston head 28. The tension screw 38, prior to actuation, retained all the components in the fixed pre-fired position as shown in FIG. 2. When the pressure exceeds the calibrated force necessary to rupture the actuator at the reduced diameter section, the movement of the primary piston head results in the actuation of the device; however, the products of the actuation gas originating from the initiator well 36, whether such gas is supplied by a cold gas supply or a pyrotechnic device, are prevented from escaping from within the actuator. Gas flow about the perimeter of the primary piston head 16 is restricted by the close tolerance fit between the piston head and the cylindrical bore of the housing 13; however, sealing rings 22 and 23 mounted within annular channel 18 also prevent such gas flow. However, in view of the extremely high pressure frequently found in such actuator operation, sometimes in excess of 9000 psi, actuator gases nevertheless may find their way past the primary piston and along the primary piston rod. The bellows 54 of the present invention provides an hermetic seal to absolutely prevent the escape of any such actuation gases from the actuator assembly.

To further insure against the escape of any such gases from the actuator assembly, and in the event of a failure or slow leak of one of the previously described sealing techniques, the tapered secondary piston 30, having been forced into the housing channel 66 by the force of the primary piston pushing on the head of the secondary piston, creates a taper seal between the secondary piston and the housing. This taper seal provides a secondary hermitic seal and also provides a locking mechanism to lock the secondary piston in the actuated mode. The cutter edge 31 of the secondary piston, when the piston is extended from the housing, ruptures the reservoir closure and permits the fluid contained within the reservoir to escape up the fluid channel 60 and out through the fluid passageway 62 into a desired fluid path to perform its intended function. It is important to note that it is critical to prevent any of the actuation gases resulting from the initiation process to escape into this fluid flow from the punctured reservoir. The multiple sealing techniques, and primarily the metal bellows, insure that none of the initiator gaseous products are permitted to contact or mingle with the fluid being delivered through the fluid channel and fluid passageway of the secondary piston.

Before the actuator is subjected to the activation of an initiator, it is frequently desirable to test the fluid flow capability and to calibrate the fluid flow characteristics of the fluid that the actuator is ultimately going to convey through its axial fluid channel or flow cavity 60 in the cutter 31 and outwardly of the fluid passageway 62. That is, when the cutter end of the secondary piston ruptures a reservoir closure, and the fluid within the reservoir exits through the axial fluid channel 60 and outwardly of the fluid passageway 62, a calibration may be necessary to insure that the fluid flow characteristics of the specific actuator are acceptable. To permit this testing and calibration without the actual activation of the actuator, the calibration/test port 56 is provided that communicates from externally of the activator housing to the cylindrical bore 67 within which the secondary piston head 28 is positioned. The calibration/test port 56 communicates to the exterior of the bellows 54, into the interior of the bore 67, around the scalloped periphery 69 of the secondary piston head 28, through a plurality of calibration channels 64 that communicate to the axial channel 60 within the cutter and the fluid passageway 62 in the cutter. Thus, a predetermined fluid pressure may be applied to the calibration/test port to permit the calibrating fluid to flow internally of the secondary piston cylindrical bore and externally of the bellows, past the scalloped periphery of the secondary piston head, into the plurality of calibration channels provided in the secondary piston, through the axial channel in the secondary piston outwardly of the fluid passageway 62. When the testing and/or calibration is complete, the calibration port is plugged and the actuator is ready for service.

The embodiment chosen for illustration incorporates a primary piston and a secondary piston, the secondary piston is formed into a cutter to perform a predetermined task in accordance with the particular application with which the chosen embodiment is to be used. It will be understood by those skilled in the art that the primary and secondary pistons may be replaced with a single piston having one end thereof shaped in an appropriate manner to accomplish the task assigned to the actuator. That is, rather than incorporate a cutter at one end of the secondary piston, a single piston with an end formed into a blade to cut cables and the like may be implemented. It is important to note that the bellows provides a hermetic seal to that portion of the actuator receiving high pressure gases from an initiator or the like and prevents any such gases from escaping from the initiator end of the actuator through the actuator to exit at an opposite end. The bellows is thus attached, such as by welding at one end thereof to an interior portion of the housing while the opposite end of the bellows is attached in a similar manner to the piston.

While the invention has been particularly shown and described herein with reference to a preferred embodiment thereof, it will be understood by those skilled in the art that various other modifications and changes may be made to the present invention from the principles of the invention as herein described without departing from the spirit and scope as encompassed in the accompanying claims. Therefore, it is intended in the appended claims to cover all such equivalent variations which may come within the scope of the invention as described.

What is claimed is:

1. An actuator comprising:
(a) a housing having a channel therein for receiving a piston;
(b) a piston mounted in said channel for limited movement along said channel from a non-actuated position to an actuated position; and
(c) a tension screw having a predetermined diameter to permit rupture in response to forces exceeding an actuation level, said screw mounted on said housing and connected to said piston to secure said piston in a non-actuated position until said screw ruptures.

2. The combination set forth in claim 1, wherein said housing has a pressure receiving end for receiving pressure from a pressure source, and wherein said piston has a piston head positioned at said pressure receiving end for movement from said non-actuated to said actuated position in response to pressure from said pressure source.

3. The combination set forth in claim 2, wherein said tension screw is mounted on said housing at said pressure receiving end to permit said piston to move from the non-actuated position to the actuated position.

4. An actuator comprising:
(a) a housing having a channel therein for receiving a piston;
(b) a piston mounted in said channel for limited movement along said channel from a non-actuated position to an actuated position; and
(c) a bellows mounted in said channel and secured by a gas-tight connection at one end thereof to said housing and at an opposite end thereof to said piston.

5. The combination set forth in claim 4, wherein said housing has a pressure receiving end for receiving fluid pressure from a pressure source, and wherein said piston has a piston head positioned at said pressure receiving end for movement from said non-actuated to said actuated position in response to fluid pressure from said pressure source.

6. The combination set forth in claim 5, wherein said tension screw is mounted on said housing at said pressure receiving end.

7. An actuator comprising:
(a) a housing having a channel therein for receiving a piston;
(b) a piston mounted in said channel for limited movement along said channel from a non-actuated position to an actuated position;
(c) a tension screw having a predetermined diameter to permit rupture in response to forces exceeding an actuation level, said screw mounted on said housing and connected to said piston to secure said piston in a non-actuated position until said screw ruptures; and
(d) a bellows mounted in said channel and secured by a gas-tight connection at one end thereof to said housing and at an opposite end thereof to said piston.

8. The combination set forth in claim 7, wherein said housing has a pressure-receiving end for receiving pressure from a pressure source and wherein said piston has a piston head positioned at said pressure receiving end for movement from said non-actuated to said actuated position in response to pressure from said pressure source.

9. The combination set forth in claim 8, wherein said tension screw is mounted on said housing at said pressure-receiving end.

10. An actuator comprising:
(a) a housing having a channel therein for receiving a piston;
(b) a piston mounted in said channel for limited movement along said channel from a non-actuated position to an actuated position;
(c) a bellows mounted in said channel and secured by a gas-tight connection at one end thereof to said housing and at an opposite end thereof to said piston; and
(d) a test port extending through said housing into said channel, said port providing fluid communication from externally of said housing to an area of said channel externally of said bellows.

11. The combination set forth in claim 1, wherein said housing has a pressure-receiving end for receiving fluid pressure from a pressure source and wherein said piston has a piston head positioned at said pressure-receiving end for movement from said non-actuated to said actuated position in response to fluid pressure from said pressure source.

12. The combination set forth in claim 2, wherein said piston has a working end opposite said piston head, said working end formed into a cutter for rupturing a container closure when said piston is moved to the actuated position.

13. The combination set forth in claim 5, wherein said piston has a working end opposite said piston head, said working end formed into a cutter for rupturing a container closure when said piston is moved to the actuated position.

14. The combination set forth in claim 7, wherein said piston has a working end opposite said piston head, said working end formed into a cutter for rupturing a container closure when said piston is moved to the actuated position.

15. The combination set forth in claim 11, wherein said piston has a working end opposite said piston head, said working end formed into a cutter for rupturing a container closure when said piston is moved to the actuated position.

16. The combination set forth in claim 15, wherein said working end has a flow cavity extending axially into said piston and including a calibration passageway extending from said flow cavity into said channel to permit fluid communication from said test port to said flow cavity.

17. The combination set forth in claim 2, wherein said piston has a working end opposite said piston head, said working end formed into a cutter for rupturing a container closure when said piston is moved to the actuated position, and wherein said working end extends outwardly through an opening provided in said housing and wherein a taper seal is formed between said opening and said working end when said piston is in the actuated position.

18. The combination set forth in claim 5, wherein said piston has a working end opposite said piston head, said working end formed into a cutter for rupturing a container closure when said piston is moved to the actuated position, said working end extending outwardly through an opening provided in said housing to form a taper seal between said opening and said working end when said piston is in the actuated position.

19. The combination set forth in claim 8, wherein said piston has a working end opposite said piston head, said working end formed into a cutter for rupturing a container closure when said piston is moved to the actuated position, said working end extending outwardly through an opening provided in said housing to form a taper seal between said opening and said working end when said piston is in the actuated position.

20. The combination set forth in claim 11, wherein said piston has a working end opposite said piston head, said working end formed into a cutter for rupturing a container closure when said piston is moved to the actuated position, said working end extending outwardly through an opening provided in said housing to form a taper seal between said opening and said working end when said piston is in the actuated position.
